(19) United States
(12) Patent Application Publication
(10) Pub. No.: US 2024/0367606 A1
(43) Pub. Date: Nov. 7, 2024

(54) INTERIOR COMPONENT FOR VEHICLES

(71) Applicant: Lisa Dräxlmaier GmbH, Vilsbiburg (DE)

(72) Inventors: Robert PUSL, Moosburg (DE); Martin RITTHALER, Gangkofen (DE)

(73) Assignee: Lisa Dräxlmaier GmbH, Vilsbiburg (DE)

(21) Appl. No.: 18/778,005

(22) Filed: Jul. 19, 2024

Related U.S. Application Data
(63) Continuation of application No. PCT/EP2023/050498, filed on Jan. 11, 2023.

(30) Foreign Application Priority Data
Jan. 20, 2022 (DE) 10 2022 101 281.6

(51) Int. Cl. B60R 21/215

(52) U.S. Cl. CPC B60R 21/215

(57) ABSTRACT

An interior component for a vehicle including a decorative layer, and a carrier that is provided between the decorative layer and an airbag holder. The airbag holder forms a chute channel for an impact cushion of an airbag. The carrier and the airbag holder are connected with each other in a connecting region in a materially bonded manner, and at least in the connecting region the airbag holder has a lower deformation resistance than the carrier.

### CROSS-REFERENCE TO RELATED APPLICATIONS

This application is a continuation of International Application No. PCT/EP2023/050498, filed on Jan. 11, 2023, which claims priority to and the benefit of DE 10 2022 101 281.6 filed on Jan. 20, 2022. The disclosure of each of the above-referenced applications is incorporated herein by reference.

### FIELD

The present disclosure relates to an interior component for vehicles.

### BACKGROUND

The statements in this section merely provide background information related to the present disclosure and may not constitute prior art.

From the prior art, interior components for vehicles are known that include a decorative layer, a carrier, and an airbag holder. When the interior component is installed in a vehicle, only the decorative layer is visible for a vehicle occupant. In the known interior components, the airbag holder and the carrier are routinely connected with each other via welding ribs. The welding ribs can thus be provided on the airbag holder, in particular overmolded, such that the welding ribs space the airbag holder from the carrier. The welding ribs can be applied either onto the carrier (heating element (HE) welding) or onto the airbag holder (infrared (IR) welding/rib welding). The spacing causes the contour of the airbag holder to be inhibited from pressing through the carrier and the decorative layer, resulting in that the airbag holder remains invisible for a vehicle occupant. The known interior components have the disadvantage that a plurality of method steps are used for the manufacturing of the interior component, and that there is an increase in material required.

### SUMMARY

This section provides a general summary of the disclosure and is not a comprehensive disclosure of its full scope or all of its features.

The interior component includes a decorative layer, a carrier, and an airbag holder. The carrier, in one example, includes natural fibers that can be mixed with a plastic matrix. The carrier is connected in a material-bonded manner with the airbag holder, and provided between the decorative layer and the airbag holder. The airbag holder has, at least in the region of the connection with the carrier, a lesser deformation resistance than the carrier.

The present disclosure also relates to a method for the manufacturing of an interior component for vehicles.

Emanating from the prior art as described above, the present disclosure provides an interior component that dispels the aforementioned disadvantages. In particular, the present disclosure provides an interior component for vehicles that is simple and cost-effective to manufacture, and also has a low net weight. The present disclosure provides a manufacturing method for such an interior component.

The present disclosure provides an interior component for vehicles that comprises a carrier and an airbag holder. The decorative layer, in particular only the decorative layer, is, in one example, visible for a vehicle occupant when the interior component is installed in a vehicle. According to the present disclosure, the carrier is disposed between the decorative layer and the airbag holder. The interior component is, in one example, connectable with the vehicle via the carrier. The carrier can, for example, be comprised of natural fibers, or at least include components of natural fibers. In particular, an airbag of the vehicle can be connected with the interior component by the airbag holder. The airbag holder forms a chute channel for an impact cushion of the airbag. The airbag holder is, in one example, configured as an attachment device for an airbag module, in particular an airbag.

According to the present disclosure, the carrier and the airbag holder are connected with each other in a material-bonded manner in a connecting region. At least in the connecting region the airbag holder has a lower deformation resistance than the carrier. Conversely this means that the carrier can have a greater deformation resistance in the connecting region than the airbag holder. For example, the airbag holder can be softer or more flexible in the connecting region than the carrier.

In the sense of this present disclosure, the deformation resistance of a body is determined by a force that the corresponding body counter-exerts against an external force acting on the body. For example, at least in the connecting region the airbag holder counter-exerts a lower force against the normalized external force acting on the airbag holder than the carrier, when the same normalized external force acts on the carrier in the connecting region.

The interior component advantageously results that, due to the lower deformation resistance, the airbag holder can be connected directly or without an intermediary with the carrier, without the contours of the airbag holder pressing through the carrier and the decorative layer. This has the advantage that, even with a connection that is direct and without an intermediary between the carrier and the airbag holder, the contours of the airbag holder remain invisible for a vehicle occupant. In addition, this interior component offers the advantage that, due to the flexibility of the airbag holder during the joining, in particular during the infrared welding, vibration welding, and/or heating element welding, less welding pressure is needed. This also advantageously results that the contours of the airbag holder cannot stand out on the decorative layer.

In a further example of the interior component the airbag holder is welded directly, in particular flush, with the carrier. With the exemplary flush connection between carrier and airbag holder, no welding ribs or projections need be provided on the carrier and/or on the airbag holder for the carrier to be able to be welded with the airbag holder spaced from the airbag holder. This has the advantage that, in the context of the manufacturing, material and additional method steps can be spared without the functionality and/or the appearance of the interior component being negatively influenced.

Alternatively, welding ribs or projections can be formed on the carrier and/or on the airbag holder. The airbag holder is, in one example, provided with welding ribs. Due to the lower deformation resistance of the airbag holder in the connecting region, the contours of the welding ribs advantageously also do not stand out on the decorative layer. The welding ribs have the advantage that due to the welding ribs the heat input during the welding can be further reduced.

In a further example of the interior component, the lower deformation resistance of the airbag holder is significantly dependent on the material. For example, at least in the connecting region the airbag holder can include a more flexible and/or softer material than the carrier. In the connecting region the airbag holder advantageously has a bending modulus of elasticity of at most 30% of the bending modulus of elasticity that the airbag holder has outside the connecting region. For example, in the connecting region the airbag holder has a bending modulus of elasticity of at most 30% of the bending modulus of elasticity that a conventional chute channel made of thermoplastic has.

The material-dependent lower deformation resistance has the advantage that, despite changed material properties, the constructive dimensions of the airbag holder can be maintained. In this context the term “substantially” is to be understood to mean that, apart from the material properties, no further constructive features such as, for example, grooves, bores, or reduced material thicknesses, contribute to the reduced deformation resistance. The lower deformation resistance of the airbag holder is, in one example, not structure-dependent. This means that the lower deformation resistance is not caused by, for example, a thinner construction method.

Alternatively, the lower deformation resistance of the airbag holder can be material- and structure-dependent. For example, at least in the connecting region the airbag holder can include a more flexible and/or softer material than the carrier, wherein in addition the material thickness of the airbag holder can be configured to be thinner than the material thickness of the carrier. The material thickness of the carrier is, in one example, configured to be thinner than the material thickness of the airbag holder.

In one exemplary further development, at least in the connecting region the airbag holder can be composed of a material that includes thermoplastic polyolefins. For example, the material can include a resin mixture made of polypropylene, non-crosslinked EPDM rubber, and polyethylene.

Independent thereof the carrier can be composed of a material that includes natural fibers. In the following the term “natural fibers” is understood to mean fibers that originate from natural sources, such as, for example, plants, animals, or minerals, and can be used directly without further chemical transformation reactions. The use of natural fibers has the advantage that the carrier can be produced in a more environmentally friendly manner. This is the case, for example, when natural fibers from renewable raw materials are used. With the use of light natural fibers, the carrier can advantageously be formed as a light component. This has the advantage that the total weight of the interior component is reduced.

In one exemplary further development of the aforementioned example, the natural fibers can be embedded in a thermoplastic plastic. The natural fibers are advantageously overmolded with thermoplastic plastic. The thermoplastic plastic can be, for example, polypropylene. The use of a thermoplastic plastic offers the advantage that the carrier can be easily manufactured and/or has a greater bending stiffness. In particular, the deformation resistance of the carrier can be increased by the use of a thermoplastic plastic.

The airbag holder can include a connecting section. The connecting section is, in one example, the section of the airbag holder that is disposed in the connecting region and is connected with the carrier.

In a further example, the airbag holder can include a retaining section. The retaining section is, in one example, configured to be connected with an airbag. For example, the retaining section can be connectable with the airbag in an interference-fit, friction-fit, and/or material-bonded manner.

The airbag holder can include a spacing section. The spacing section can be configured to space the airbag from the carrier. The spacing section, in one example, forms the chute channel. Alternatively or additionally, the connecting section can be connected with the retaining section via the spacing section.

In one exemplary further development, the airbag holder of the interior component can comprise various materials. For example, the airbag holder can include a first material and a second material, in particular be composed of a first and a second material. The first material is, in one example, more flexible or softer than the second material. This means that the first material can have a lower deformation resistance than the second material. For example, the first material can be comprised of a thermoplastic polyolefin, and the second material can be comprised of a thermoplastic, in particular of polypropylene.

The first material is, in one example, provided in the connecting region, in particular in the connecting section of the airbag holder. The second material can be provided in the retaining section of the airbag holder. This advantageously causes that in the retaining region the airbag holder has the desired stiffness, and in the connecting region has the lowest possible deformation resistance.

In a further advantageous example, in the connecting region the airbag holder, the carrier, and the decorative layer are configured to be able to be pierced by an impact cushion of an airbag. For example, the airbag holder, the carrier, and the decorative layer are pierced by an impact cushion of an airbag when the airbag triggers or has been triggered. This can in particular be the case when an impact event occurs with the vehicle in which the interior component is installed.

In one exemplary further development the carrier and/or the airbag holder can include a predetermined breaking point in the connecting region. For example, the carrier and/or the airbag holder bursts/burst open at the predetermined breaking point when they are penetrated by the impact cushion of the airbag. In the connecting section the carrier, in one example, comprises a predetermined breaking point. In the connecting section the airbag holder can include predetermined breaking points and/or an opening.

The chute channel formed by the airbag holder, in particular by the spacing section of the airbag holder, is, in one example, configured to guide the impact cushion of the airbag toward the connecting region. This has the advantage that the impact cushion exits from the interior component, in particular from the decorative layer, at a predefined position of the interior component. The predefined position is, in one example, provided in the connecting region.

In a further example of the interior component the airbag holder comprises at least one hinge, in one example, two hinges. The hinge is, in one example, configured such that the airbag holder can unfold via the hinge when the airbag is triggered. The hinge includes the same material as the airbag holder in the connecting region. The hinge can be composed of the same material as the airbag holder in the connecting region. This advantageously results that, when the airbag is triggered, the airbag holder can unfold more easily. Due to the low deformation resistance of the airbag holder at the hinges, the flexibility of the hinges can be increased. This has the advantage that an impact cushion of the triggered airbag can reach more easily into the interior of the vehicle in which the interior component is installed.

The present disclosure also relates to a method for the manufacturing of an interior component according to the above examples. In the manufacturing method the carrier and the airbag holder are, in one example, welded together in the connecting region by infrared welding, vibration welding, and/or heating element welding. This has the advantage that the joining between carrier and airbag holder is affected under a lowest-possible thermal load. Undesired deformations of the carrier and/or of the decorative layer can thereby be avoided.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a sectional view of an interior component according to one example of the present disclosure; and

FIG. 2 shows the sectional view of the example according to FIG. 1, in which an airbag is connected with the interior component.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

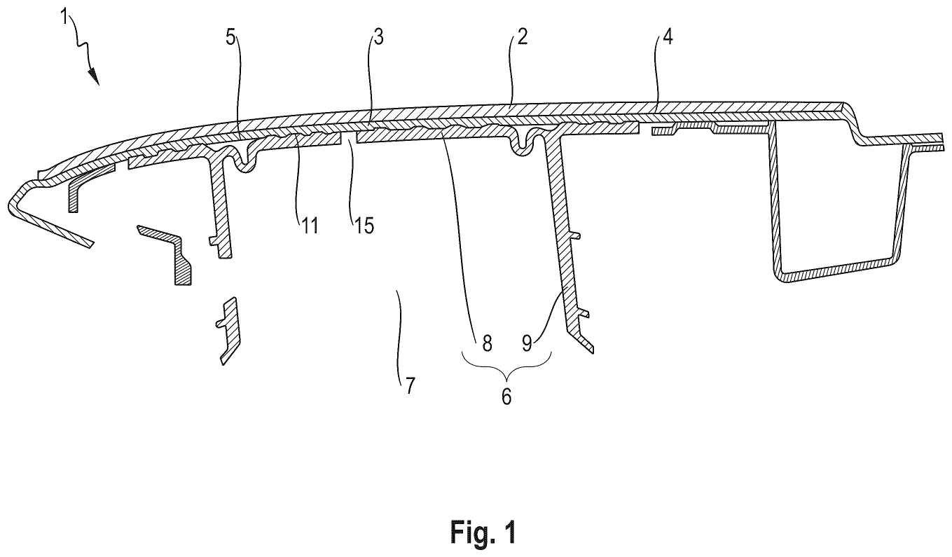

FIG. 1 shows an example of an interior component 1 for a vehicle in a sectional view. The interior component 1 comprises a decorative layer 2, a carrier 3, and an airbag holder 6.

The carrier 3 is disposed between the decorative layer 2 and the airbag holder 6. For a vehicle occupant only the decorative layer 2 is visible when the interior component is installed in a vehicle. The decorative layer 2 can be, for example, leather, artificial leather, Alcantara, or a plastic layer. Alternatively or additionally, the decorative layer 2 can have a textile surface. The decorative layer 2 is disposed on a first surface 4 of the carrier 3. For example, the decorative layer 2 can be adhered onto the first surface 4.

In the example depicted, the carrier 3 is composed of a material that comprises a mixture of natural fibers and a thermoplastic, for example, polypropylene. In one example, the natural fibers are embedded in the thermoplastic, or overmolded with thermoplastic.

The carrier 3 includes a second surface 5 opposing the first surface 4. In a section of the second surface 5, the carrier 3 is connected with the airbag holder 6, in particular connected with the airbag holder 6 in a material-bonded manner. The region in which the carrier 3 is connected with the airbag holder 6 is referred to in the following as the connecting region 11. The carrier 3 and the airbag holder 6 are, in one example, directly connected with each other in the connecting region 11 by infrared welding and/or vibration welding. In another example, heating element welding may be used. This means that no further components, such as, for example, welding ribs, are provided between the carrier 3 and the airbag holder 6. The carrier 3 and the airbag holder 6 are connected with each other in a connecting region 11 in a materially bonded manner.

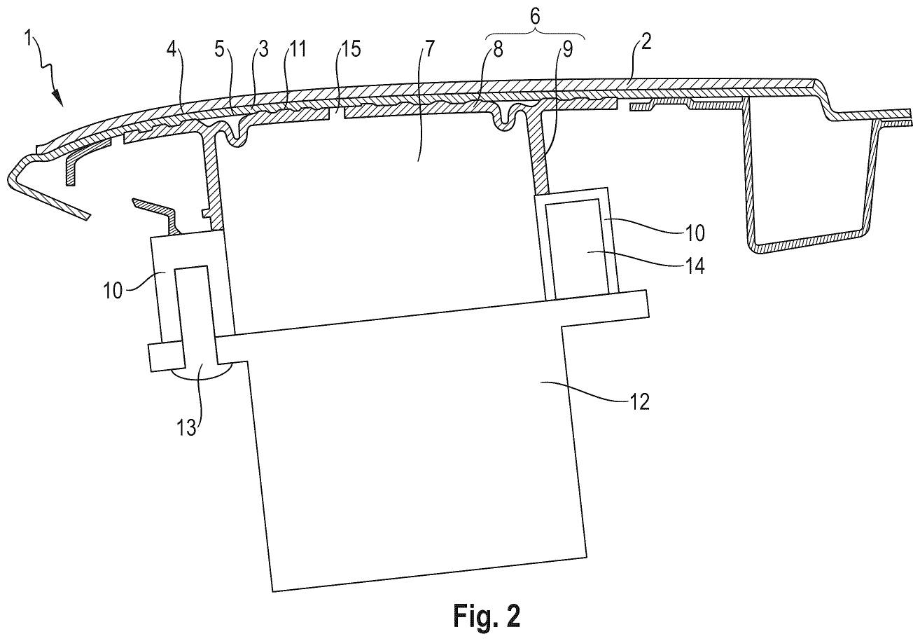

In the example depicted in FIG. 1, the airbag holder 6 is formed such that the airbag holder 6 forms a chute channel 7. With respect to the functionality of the chute channel 7, reference is made to the description of FIG. 2. The airbag holder 6 comprises a connecting section 8, a spacing section 9, and a retaining section 10 shown in FIG. 2.

The connecting section 8 extends substantially in the entire connecting region 11. At least in the connecting region 11, in particular in the connecting section 8, the airbag holder 6 has a lower deformation resistance than the carrier 3. This means that at least in the connecting region 11, in particular in the connecting section 8, the airbag holder 6 is softer than the carrier 3. This is, in one example, caused by the airbag holder 6 being composed of a softer material, at least in the connecting region 11, in particular in the connecting section 8, than the carrier 3. At least in the connecting region 11, in particular in the connecting section 8, the airbag holder 6 is composed of a material that includes thermoplastic polyolefins, for example, a resin mixture of polypropylene, uncrosslinked EPDM rubber, and polyethylene.

In the connecting section 8 the airbag holder 6 includes a predetermined breaking point 15. The predetermined breaking point 15 is configured such that the airbag holder 6 breaks at the predetermined breaking point 15 when, for example, an airbag connected with the airbag holder 6 triggers.

The spacing section 9 of the airbag holder 6 is configured to space an airbag, not shown in FIG. 1, from the carrier 3. The spacing section 9 simultaneously forms the chute channel 7. The connecting section 8 is connected with the retaining section 10 via the spacing section 9.

FIG. 2 shows the example of the interior component 1 according to FIG. 1, in which an airbag 12 is connected with the interior component 1 via the airbag holder 6.

The airbag 12 is disposed on the retaining section 10 of the airbag holder 6. As is shown in FIG. 2, the airbag 12 is connected with the retaining section 10 via a first connection 13 (left) and a second connection 14 (right). The first connection 13 is a friction-fit connection, in particular a screw connection 13. The second connection 14 is an interference-fit connection, in particular a click- or snap-connection 14. In alternative examples it is conceivable that the airbag 12 is connected with the airbag holder 6, in particular the retaining section 10, exclusively in an interference-fit, friction-fit, or material-bonded manner.

In the retaining section 10 the airbag holder 6 is composed of a material that differs from the material in the connecting region 11, in particular in the connecting section 8. The material in the retaining section 10, in one example, has a greater deformation resistance than the material in the connecting region 11, in particular in the connecting section 8. This means that the material of the airbag holder 6 in the connecting region 11, in particular in the connecting section 8, is more flexible than the material in the retaining section 10.

The connecting sections 8 of the airbag holder 6 are formed loop-shaped near the spacing section 9. Due to the loop shape, the connecting sections 8 form hinges on the loops. The hinges make possible a smooth unfolding of the airbag holder 6 when the airbag 12 is triggered.

As shown in FIG. 2, the airbag holder 6, in particular the spacing section 9, forms the chute channel 7. The chute channel 7 serves for the guiding of an impact cushion of the airbag 12.

As soon as the airbag 12 triggers, for example, in the event of a collision, the airbag 12 ejects an impact cushion. Here the impact cushion is ejected from the airbag 12 into the chute channel 7. Via the chute channel 7 the impact cushion is guided toward the connecting region 11, in particular toward the connection section 8 and the predetermined breaking point 15. As soon as the impact cushion impinges against the predetermined breaking point 15, the airbag holder 6 is pierced or penetrated at the predetermined breaking point 15 by the impact cushion. Here the overlying carrier 3 and the decorative layer 2 also tear open at corresponding points. The impact cushion can then exit from the interior component 1 at the surface of the decorative layer 2 facing away from the carrier 3.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An interior component for a vehicle, the interior component comprising:
a decorative layer; and
a carrier disposed between the decorative layer and an airbag holder, the airbag holder defines a chute channel for an impact cushion of an airbag, the carrier and the airbag holder are connected with each other in a connecting region in a materially bonded manner, and at least in the connecting region, the airbag holder has a lower deformation resistance than the carrier.

2. The interior component according to claim 1, wherein the airbag holder includes a more flexible material in the connecting region than the carrier to result in the lower deformation resistance.

3. The interior component according to claim 1, wherein the carrier is composed of a material that includes natural fibers.

4. The interior component according to claim 3, wherein the material of the carrier includes a thermoplastic, and the natural fibers are embedded in the thermoplastic.

5. The interior component according to claim 1, wherein at least in the connecting region, the airbag holder is composed of a material that includes thermoplastic polyolefins.

6. The interior component according to claim 1, wherein the airbag holder includes a retaining section that is configured to connect with the airbag.

7. The interior component according to claim 6, wherein the airbag holder includes a first material in the connecting region and a second material in the retaining section, wherein the first material is more flexible than the second material.

8. The interior component according to claim 1, wherein the airbag holder, the carrier, and the decorative layer are configured to be penetrated in the connecting region by the impact cushion of the airbag.

9. The interior component according to claim 1, wherein the airbag holder includes at least one hinge for unfolding the airbag holder during triggering of the airbag, wherein the at least one hinge includes a material that is the same as a material of the airbag holder in the connecting region.

10. A method for manufacturing of an interior component according to claim 1, wherein the carrier and the airbag holder are welded together in the connecting region by at least one of infrared welding, vibration welding, and heating element welding.
